(19) United States
(12) Patent Application Publication
(10) Pub. No.: US 2026/0310966 A1
(43) Pub. Date: Oct. 8, 2026

(54) TRAINING A NEURAL NETWORK MODEL USING TAILORED SHARPNESS MINIMIZATION

(71) Applicant: GDM Holding LLC, Mountain View, CA (US)

(72) Inventors: Atish Agarwala, Sunnyvale, CA (US); Yann Nicolas Dauphin, Montreal (CA); Hossein Mobahi, Mountain View, CA (US); Sidak Pal Singh, Zürich (CH)

(21) Appl. No.: 19/459,815

(22) Filed: Jan. 26, 2026

Related U.S. Application Data
(60) Provisional application No. 63/751,788, filed on Jan. 30, 2025.

(51) Int. Cl. G06N 3/084

(52) U.S. Cl. CPC G06N 3/084

(57) ABSTRACT

Methods, systems, and apparatus, including computer programs encoded on a computer storage medium, for training a neural network in accordance with optimizing a particular measure of sharpness. In one aspect, a method comprises receiving a set of training examples, each including an input and target output, generating a respective predicted output using the neural network for each training example, computing a first gradient of a loss function with respect to a set of parameter values of the neural network model using the respective predicted outputs for the inputs, determining, using the first gradient, a perturbation vector that results in a perturbed set of parameter values that optimizes a measure of functional sharpness, computing a second gradient of the loss function of the perturbed set of parameter values of the neural network model, and updating the set of parameter values of the neural network model in accordance with the second gradient.

### CLAIM OF PRIORITY

This application claims priority under 35 USC § 119(e) to U.S. Patent Application Ser. No. 63/751,788, filed on Jan. 30, 2025, the entire contents of which are hereby incorporated by reference.

### BACKGROUND

This specification relates to processing data using machine learning models.

Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input to generate an output.

### SUMMARY

This specification describes a system implemented as computer programs on one or more computers in one or more locations that can train a neural network model in accordance with optimizing a measure of sharpness for the neural network model at each of a number of training iterations. In this context, sharpness refers to the neural network model's sensitivity to changes, e.g., in the inputs, the set of parameter values, or training conditions.

Generally, large measures of sharpness are associated with poor generalization capabilities by a neural network model. In particular, generalization can refer to the ability of the neural network model to generate accurate outputs for inputs that differ from those included in training data, generate accurate outputs when processing new inputs that have different properties and that reflect a distribution shift relative to the training data, and adapt to specialized tasks through fine-tuning on specific domains. For example, a neural network with a large measure of loss landscape sharpness, which indicates that small changes to the set of parameter values result in large changes in the loss function, is more likely to perform poorly when processing out of distribution samples during inference.

More specifically, the system of this specification can train a neural network model to optimize a particular measure of sharpness during training. At each of a number of training iterations, the system can perturb the set of parameter values of the neural network model along either (i) a direction that optimizes a measure of functional sharpness or (ii) a direction that optimizes a measure of logit sharpness, and can update the set of parameter values in accordance with a gradient of an objective function determined using the perturbed set of parameter values. In particular, the system can apply, e.g., add, the perturbation vector to the set of parameter values, e.g., a proper subset of the set of parameter values or the full set of parameter values, to generate the perturbed set of parameter values.

In this specification, functional sharpness refers to how sensitive a neural network model's output predictions are to a change in the set of parameter values, e.g., a tendency of the predicted outputs for each of the inputs to change when the set of parameter values are perturbed.

In this specification, logit sharpness refers to how sensitive the logits used in calculating the loss function for the neural network model are to a change in the set of parameter values, e.g., a tendency of logits used in calculating the loss function to change when the set of parameter values are perturbed.

According to a first aspect there is provided a method for receiving a set of training examples, wherein each training example comprises an input and target output, for each training example, generating a respective predicted output by processing the input using the neural network model in accordance with a set of parameter values of the neural network model, computing a first gradient of a loss function with respect to the set of parameter values of the neural network model using the respective predicted outputs for the inputs, determining, using the first gradient, a perturbation vector that results in a perturbed set of parameter values that optimizes a measure of functional sharpness, wherein the perturbed set of parameter values are generated by applying the perturbation vector to the set of parameter values, computing a second gradient of the loss function of the perturbed set of parameter values of the neural network model, and updating the set of parameter values of the neural network model in accordance with the second gradient.

Particular embodiments of the subject matter described in this specification can be implemented so as to realize one or more of the following advantages.

Ensuring generalization capabilities remains a challenge in training neural network models. Generally, neural network models have a tendency to learn parameters that overfit the training data, reducing the model's ability to perform accurately on data that is not included in the training data or that has different properties from the training data.

Sharpness regularization techniques, including Sharpness Aware Minimization, are a class of optimization methods designed to bias the learning process toward regions of the loss landscape with lower curvature. While sharpness regularization techniques often are effective in improving generalization when training neural networks to perform vision tasks, they often perform worse than standard optimizers (e.g., AdamW), despite higher computational costs, when training neural networks to perform natural language processing tasks due to spurious effects of the dominance of modifications to the logit statistics, which causes the neural network to minimize sharpness by becoming over-confident in its predicted outputs rather than improving the underlying functional geometry of the loss landscape.

In contrast to general curvature regularization techniques, the techniques of this specification allow for the training of neural network models through tailored sharpness optimization. Specifically, the system of this specification provides for training a neural network model using (i) functional sharpness optimization, or (ii) logit sharpness optimization. Thus, the system can prevent spurious results from the general minimization of the loss landscape sharpness, which, in some cases, can result in the optimization of only the functional sharpness or the logit sharpness to the detriment of the generalization of the model.

By allowing for the flexibility to tailor the update of the set of parameter values along a particular sharpness optimization pathway at a particular training iteration as defined by the perturbation vector, the system can promote advantageous generalization across different types of training tasks. For example, reducing functional sharpness by encouraging simplicity of the modeled function can result in better target output modelling and state-of-the-art performance for generative neural network models, e.g., token generation neural network models. As another example, reducing both functional sharpness and loss landscape sharpness can result in improved performance for computer vision neural network models. In some cases, training using either functional sharpness optimization or logit sharpness optimization for a portion of the training iterations, and then switching to optimizing the other measure of sharpness for the remainder of the training iterations can be advantageous to generalizing to the training task. In other cases, training using the measure of loss landscape sharpness, and then switching to optimizing either the functional sharpness or the logit sharpness for the remainder of training iterations can be advantageous to generalizing to the training task.

Furthermore, the system of this specification can result in trained neural network models that demonstrate enhanced generalization performance relative to neural network models that are trained without optimizing for any measures of sharpness during the training process. By allowing for the training of more generalizable neural network models, the system can prevent the need to retrain a particular neural network model often, e.g., in response to every change detected in the data distribution of inputs during inference.

Moreover, while involving an extra gradient calculation, in some cases, the system can reduce the use of overall computational resources required to train the neural network model since better generalization can lead to more stable training and faster convergence, e.g., fewer training iterations and fewer needed data samples. Additionally, by promoting generalization through the optimization of the functional, logit sharpness, or some combination, the system can bypass the need to use heavy regularization methods in order to attain generalization, thereby avoiding introducing extra computational requirements required for incorporating regularization into training.

Additionally, unlike curvature-aware training techniques that focus solely on reducing the measure of loss landscape sharpness, the techniques of this specification can achieve improved generalization performance on language modeling tasks using a token generation neural network model, e.g., a language model. More specifically, the ability of the system to provide for updating the set of parameter values of the neural network model in the direction of optimizing functional sharpness prevents the optimization of the logit sharpness from dominating in a method that minimizes the measure of loss landscape sharpness alone, e.g., in contrast to Sharpness Aware Minimization. In an example implementation disclosed, the techniques of this specification that involve optimizing the measure of functional sharpness provide generalization benefits for Nanodo decoder-only transformer models over training with baseline AdamW with respect to the C4 dataset. In this case, the additional usage of a diagonal preconditioner matrix to eliminate the logit sharpness component can further enhance the generalization gains. The combined method improves validation metrics in both fixed number of steps as well as Chinchilla scaling settings at a variety of model sizes, thereby demonstrating a successful sharpness-aware training application in a language modelling task at scale. In particular, the system of this specification is able to prevent overconfidence in language model predictions by encouraging the update of the model parameters along a direction that optimizes the functional sharpness.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a system diagram of an example sharpness-aware training system that includes a sharpness-aware loss engine.

FIG. 2 is a block diagram of an example sharpness-aware loss engine.

FIG. 3 illustrates the difference between functional sharpness and logit sharpness for four different transformer models.

FIG. 4 is a flow diagram of an example process for training a neural network to optimize a measure of functional sharpness.

FIG. 5 is a flow diagram of an example process for training a neural network to optimize a measure of logit sharpness.

### DETAILED DESCRIPTION

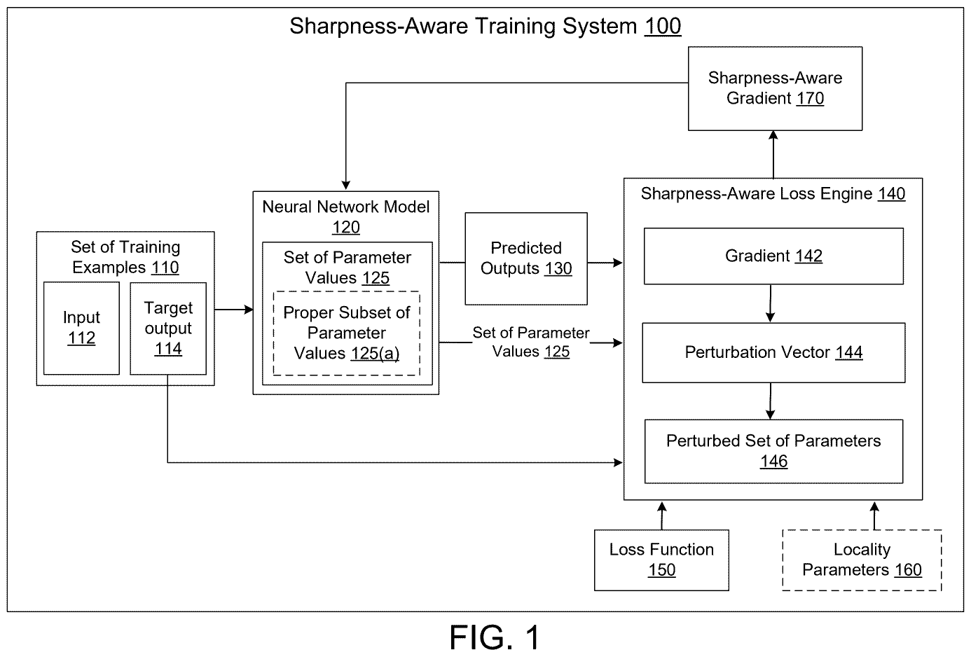

FIG. 1 shows an example sharpness-aware training system 100. The sharpness-aware training system 100 is an example of a system implemented as computer programs on one or more computers in one or more locations in which the systems, components, and techniques described below are implemented.

The system 100 trains a neural network model 120 on training data that includes a set of training examples 110. The neural network model 120 includes a set of parameters, e.g., weights and biases, that are updated at each of a number of training iterations. In more detail, the system 100 can train the neural network model 120 on the set of training examples 110 by updating one or more parameters of the neural network model 120 by a machine learning training technique to optimize an objective function at each of the training iterations.

The objective function can measure, for each training example, a discrepancy between: (i) the target output 114 specified by the training example, and (ii) the predicted output generated by neural network model 120 by processing the input 112 of the training example. The objective function can measure a discrepancy between target and predicted outputs in any appropriate way, e.g., using a cross-entropy loss or a mean squared error loss. The machine learning training technique can be any technique appropriate for training the neural network model 120, e.g., a stochastic gradient descent training technique.

In particular, the system 100 can update the parameters of the neural network model 120 by calculating and backpropagating gradients of an objective function to update parameter values of the model, e.g., using the update rule of any appropriate gradient descent optimization algorithm. For example, the system 100 can train the neural network model 120 to minimize a particular measure of sharpness at each of a number of training iterations.

In more detail, the system 100 can perturb the set of parameter values of the neural network model along either (i) direction that optimizes a measure of functional sharpness or (ii) a direction that optimizes a measure of logit sharpness, and can update the set of parameter values in accordance with a gradient of an objective function determined using the perturbed set of parameter values.

The sharpness-aware training system 100 includes a neural network model 120 and a sharpness-aware loss engine 140. The sharpness-aware training system 100 is configured to train the neural network model 120 using a set of training examples 110 to optimize a measure of functional sharpness, logit sharpness, or both. In this context, functional sharpness refers to a sensitivity of the output predictions of the neural network model 120 to changes in a set of parameter values 125, and logit sharpness refers to a sensitivity of the logits used in calculating a loss function 150 for the neural network model 120 to changes in the set of parameter values 125.

For example, each training example set of training examples 110 can include an input 112 and a target output 114. For example, the input 112 can be a sequence of tokens from a natural language dataset, e.g., the Colossal Clean Crawled Corpus (C4) dataset, and the target output 114 can be a next token in the sequence specified by the dataset. As another example, the input 112 can be an image from a vision dataset, such as ImageNet or JFT-300M image dataset, and the target output 114 can be a classification label for the image specified by the dataset.

The neural network model 120 can have any appropriate architecture, e.g., the neural network model can have any appropriate number of neural network layers (e.g., 1 layer, 5 layers, or 10 layers) of any appropriate type (e.g., fully-connected layers, attention layers, convolutional layers, etc.) connected in any appropriate configuration (e.g., as a linear sequence of layers, or as a directed graph of layers).

In some implementations, the neural network model 120 can be a language model neural network, i.e., an auto-regressive neural network that generates output sequences of tokens from a vocabulary, e.g., conditioned on a context sequence.

As an example, the tokens in the vocabulary can be text tokens, such that the language model neural network maps a context sequence of text tokens to an output sequence of text tokens. As another example, the language model neural network can be a multi-modal neural network, with the tokens in the context sequence including tokens representing another data modality, e.g., images, videos, or audio, instead of or in addition to text tokens.

In this case, the neural network model is referred to as an auto-regressive neural network because neural network model auto-regressively generates an output sequence of tokens by generating each particular token in the output sequence conditioned on a current input sequence that includes any tokens that precede the particular text token in the output sequence, i.e., the tokens that have already been generated for any previous positions in the output sequence that precede the particular position of the particular token, and a context input that provides context for the output sequence. For example, the current input sequence when generating a token at any given position in the output sequence can include the context sequence and the tokens at any preceding positions that precede the given position in the output sequence. As a particular example, the current input sequence can include the context sequence followed by the tokens at any preceding positions that precede the given position in the output sequence. Optionally, the context and the current output sequence can be separated by one or more predetermined tokens within the current input sequence.

More specifically, to generate a particular token at a particular position within an output sequence, the neural network model can process the current input sequence to generate a score distribution, e.g., a probability distribution, that assigns a respective score, e.g., a respective probability, to each token in the vocabulary of tokens. The neural network model 120 can then select, as the particular token, a token from the vocabulary using the score distribution. For example, the neural network model can greedily select the highest-scoring token or can sample, e.g., using nucleus sampling or another sampling technique, a token from the distribution.

For example, the neural network model can be an auto-regressive Transformer-based neural network that includes (i) a plurality of attention blocks that each apply a self-attention operation and (ii) an output subnetwork that processes an output of the last attention block to generate the score distribution. In particular, the neural network model 120 can be an encoder-decoder transformer, an encoder-only transformer, or a decoder-only transformer, configured to perform parallel processing of the contents of the multimodal input using a multi-headed attention mechanism and trained to perform next element prediction, e.g., to define a likelihood score distribution over a set of next elements.

The neural network model 120 can have any of a variety of Transformer-based neural network architectures. For example, the neural network model 120 can have an architecture including those described in J. Hoffmann, S. Borgeaud, A. Mensch, E. Buchatskaya, T. Cai, E. Rutherford, D. d. L. Casas, L. A. Hendricks, J. Welbl, A. Clark, et al. Training compute-optimal large language models, arXiv preprint arXiv:2203.15556, 2022; J. W. Rae, S. Borgeaud, T. Cai, K. Millican, J. Hoffmann, H. F. Song, J. Aslanides, S. Henderson, R. Ring, S. Young, E. Rutherford, T. Hennigan, J. Menick, A. Cassirer, R. Powell, G. van den Driessche, L. A. Hendricks, M. Rauh, P. Huang, A. Glaese, J. Welbl, S. Dathathri, S. Huang, J. Uesato, J. Mellor, I. Higgins, A. Creswell, N. McAleese, A. Wu, E. Elsen, S. M. Jayakumar, E. Buchatskaya, D. Budden, E. Sutherland, K. Simonyan, M. Paganini, L. Sifre, L. Martens, X. L. Li, A. Kuncoro, A. Nematzadeh, E. Gribovskaya, D. Donato, A. Lazaridou, A. Mensch, J. Lespiau, M. Tsimpoukelli, N. Grigorev, D. Fritz, T. Sottiaux, M. Pajarskas, T. Pohlen, Z. Gong, D. Toyama, C. de Masson d'Autume, Y. Li, T. Terzi, V. Mikulik, I. Babuschkin, A. Clark, D. de Las Casas, A. Guy, C. Jones, J. Bradbury, M. Johnson, B. A. Hechtman, L. Weidinger, I. Gabriel, W. S. Isaac, E. Lockhart, S. Osindero, L. Rimell, C. Dyer, O. Vinyals, K. Ayoub, J. Stanway, L. Bennett, D. Hassabis, K. Kavukcuoglu, and G. Irving. Scaling language models: Methods, analysis & insights from training gopher. CoRR, abs/2112.11446, 2021; Colin Raffel, Noam Shazeer, Adam Roberts, Katherine Lee, Sharan Narang, Michael Matena, Yanqi Zhou, Wei Li, and Peter J Liu. Exploring the limits of transfer learning with a unified text-to-text transformer. arXiv preprint arXiv:1910.10683, 2019; Daniel Adiwardana, Minh-Thang Luong, David R. So, Jamie Hall, Noah Fiedel, Romal Thoppilan, Zi Yang, Apoorv Kulshreshtha, Gaurav Nemade, Yifeng Lu, and Quoc V. Le. Towards a human-like open-domain chatbot. CoRR, abs/2001.09977, 2020; “Gemini: A Family of Highly Capable Multimodal Models” (arXiv:2312.11805); and “Gemma 3 Technical Report” (arXiv:2503.19786).

and Tom B Brown, Benjamin Mann, Nick Ryder, Melanie Subbiah, Jared Kaplan, Prafulla Dhariwal, Arvind Neelakantan, Pranav Shyam, Girish Sastry, Amanda Askell, et al., Language models are few-shot learners. arXiv preprint arXiv:2005.14165, 2020. As a related example, the neural network model 120 can be a Nanodo model, e.g., as is described in more detail in Liu, P., et. al.

“NanoDO: A minimal Transformer decoder-only language model implementation in JAX”.

Generally, however, the Transformer-based neural network includes a sequence of attention blocks (a block that applies an attention mechanism over a block input to generate a block output), and, during the processing of a given input sequence, each attention block in the sequence receives a respective input hidden state for each input token in the given input sequence. The attention block then updates each of the hidden states at least in part by applying self-attention to generate a respective output hidden state for each of the input tokens. The input hidden states for the first attention block are embeddings of the input tokens in the input sequence and the input hidden states for each subsequent attention block are the output hidden states generated by the preceding attention block.

As another example, the neural network model can be a visual language model (VLM) that can be configured to process an image or sequence of images in a video to generate an intermediate representation of the image and perform an image processing task. For example, the base network can be a contrastive language-image pre-training (CLIP) model, a vision transformer (ViT), a unified image-to-image translation (UNIT) model, or an attention generative adversarial network (AttnGAN).

In this case, the image processing task can involve generating an output that requires reasoning, e.g., spatio-temporal reasoning, to respond to a natural language query input, e.g., relating to a moving image (video). For example, such a query may require predictive reasoning (“what will happen next”), counterfactual reasoning (“what would happen in a different circumstance”), explanatory reasoning (“why did something happen”), or causal reasoning generally. For example, the image representation can be used to detect objects in the video frames and provide information relating to the detected objects in response to a query, e.g., a request for a prediction of a future event or state relating to one or more of the objects (e.g., “will objects X and Y collide?”), or a request for conditional or counterfactual information relating to one or more of the objects (e.g., “what event would [not] happen if object X is modified, moved or absent?”), or a request for analysis of the video frames to determine a property or characteristic of one or more of the objects (e.g., “how many objects of type Z are moving?”). The output may, for example, be in the form of a yes/no answer, or may define a probability distribution over a set of possible answers; or the response may define the location of an object. Such a base network can be used to predict whether or not two objects will collide, or how this may be avoided. The output may be used e.g., to provide a warning, to control motion of one or more of the objects, or both.

The system 100 can train the neural network model 120 at each of a number of training iterations. During each training iteration, the system 100 can process one or more the inputs 112 from the set of training examples 110 using the neural network model 120 to generate respective outputs 130 for each of the training examples 110. In more detail, at each iteration, the neural network model 120 processes the input 112 in accordance with the set of parameter values 125 at the current iteration to generate the predicted output 130 for the input 112.

Generally, the predicted output 130 can be determined from a set of logits representing a probability distribution over a vocabulary of tokens or a set of scores for different object categories. In this context, the logits are likelihood or pseudo-likelihood values determined by one of the final layers of the neural network model 120, e.g., which are used to determine the predicted output 130 through sampling. For example, the neural network model 120 can greedily select the tokens with the highest likelihood or pseudo-likelihood values to determine the predicted output 130. As another example, the neural network model 120 can determine the predicted output 130 from the set of logits through nucleus or top-k sampling.

The system 100 can process the predicted outputs 130 and the target outputs 114 using a sharpness-aware loss engine 140. The sharpness-aware loss engine 140 can compute a gradient 142 of the loss function 150 with respect to the set of parameter values 125. In particular, the system 100 can compute a gradient of a loss function with respect to the set of parameter values of the neural network model, e.g., ∇_{θ} L(θ), by determining the gradient of a discrepancy between a target output 114 for each of the set of training examples 110 and the predicted output 130 generated using the current set of parameter values of the neural network model 120. As an example, the discrepancy can be measured using a cross-entropy loss or a mean squared error loss.

The sharpness-aware loss engine 140 can use the gradient 142 to determine a perturbation vector 144, e.g., an organized set of values that, when applied to the set of parameter values 125 or a subset 125(a) of the set of parameter values, yields a perturbed set of parameters 146. In particular, the sharpness-aware loss engine 140 can identify the perturbation vector 144 such that the perturbed set of parameters 146 optimizes a specific measure of sharpness: either a functional or a logit sharpness.

More specifically, the sharpness-aware loss engine 140 can perform a min-max optimization on the quantity min_{θ} max_{∥ϵ∥≤ρ} L(θ+ϵ), where ϵ is the perturbation vector 144 applied to the set of parameter values 125 that maximizes a measure of loss landscape sharpness. For example, consistent with Sharpness Aware Minimization, e.g., as is described in detail in Foret, P., et. al. “Sharpness-Aware Minimization for Efficiently Improving Generalization” (arXiv:2010.01412v3 2021), the sharpness-aware loss engine 140 can generate a maximal loss perturbation vector that approximates the optimal perturbation vector ϵ*(θ)=ρ ∇_{θ}L(θ)/∥∇_{θ}L(θ)∥, where ρ is a vector including one or more locality parameters 160 that define the perturbation radius, e.g., neighborhood, around the set of parameter values 125 where sharpness is measured. In this case, the approximation of the optimal perturbation vector ϵ* is determined within a neighborhood defined by the values of the locality parameters 160.

For example, the one or more locality parameters 160 can be one or more fractional values, whole values, or identity values (1). In the case that ρ is a single value, ρ defines the same perturbation radius across different parts of the network. In the case that ρ is a vector including multiple values, ρ specifies different perturbation radii, e.g., that establish different neighborhoods around the set of parameter values 125 where sharpness is measured across different layers or sub-units of the neural network model 120. In this case, one or more of the locality parameters in ρ can be zero, e.g., to specify that the perturbation be applied selectively to a proper subset of the parameter values of the neural network model 120.

In this context, the approximation of the optimal perturbation vector ϵ*, which provides a measure of loss landscape sharpness, is determined by approximating the inner maximization to the first order as

$${max}_{‖ ϵ ‖ \leq ρ} ℒ ( θ ) + {ϵ}^{T} {∇}_{θ} ℒ ( θ ) \qquad ( 1 )$$

However, rather than applying the approximation of ϵ* as the perturbation vector 144, the sharpness-aware loss engine 140 can isolate a functional sharpness perturbation vector and a logit sharpness perturbation vector using ϵ* and the gradient 142.

In this context, functional sharpness refers to how sensitive a neural network model's output predictions are to a change in the set of parameter values, e.g., a tendency of the predicted outputs for each of the inputs to change when the set of parameter values are perturbed. In particular, functional sharpness measures whether the output predictions for a set of training examples change in a meaningful way due to a perturbation in the set of parameter values. As an example, a high measure of functional sharpness can indicate that the output predicted classes for a large number of training examples flipped in a binary classification training task.

In this context, logit sharpness refers to how sensitive the logits used in calculating the loss function for the neural network model are to a change in the set of parameter values, e.g., a tendency of logits used in calculating the loss function to change when the set of parameter values are perturbed. In this case, a change in the logits directly affects intermediate probabilities that are used to generate a predicted output for a given input. As a simple example, a high measure of logit sharpness can indicate that the logits for a set of training examples change in a meaningful way due to a perturbation in the set of parameter values.

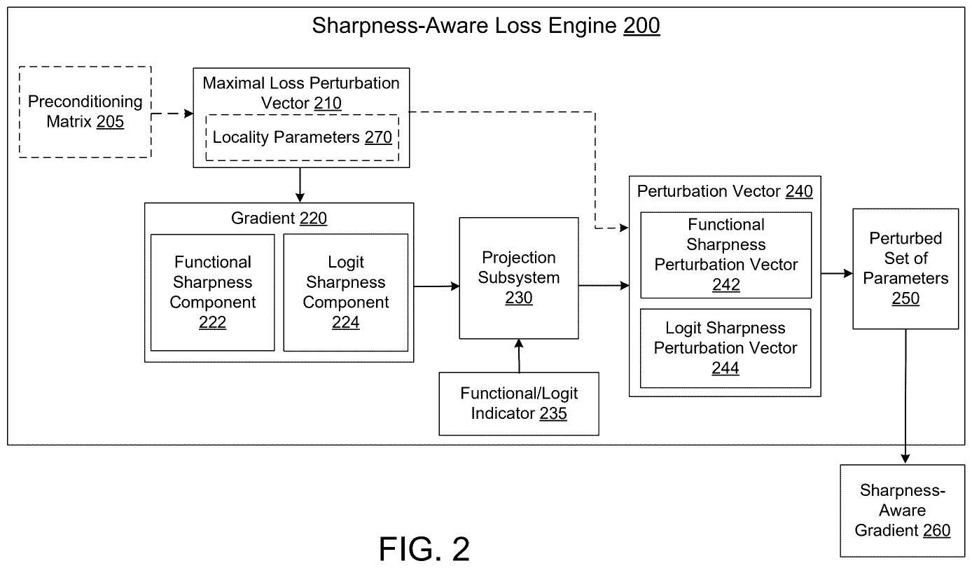

More specifically, the sharpness-aware loss engine 140 can determine a maximal loss perturbation vector that approximates the optimal perturbation vector ϵ* that results in a perturbed set of parameter values that maximizes the sharpness of the loss landscape defined by the loss function 150, and can determine either a functional sharpness perturbation vector or a logit sharpness perturbation vector using the maximal loss perturbation vector and the gradient 142 as the perturbation vector 144, e.g., as is described briefly below and in more detail with respect to FIG. 2.

In particular, the sharpness-aware loss engine 140 can decompose the maximal loss perturbation vector to provide either a functional sharpness minimization path or a logit sharpness minimization path. More specifically, the update along the direction of the optimal perturbation vector:

$${g}_{SAM} = - {∇}_{θ} ℒ ( θ + p {ϵ}^{*} ) , {ϵ}^{⋆} ≡ \frac{{∇}_{θ} ℒ ( θ )}{‖ {∇}_{θ} ℒ ( θ ) ‖} \qquad ( 2 )$$

can be simplified to first order in ρ as:

$${min}_{θ} ℒ ( θ ) + {\underbrace{ρ ‖ {∇}_{θ} ℒ ( θ ) ‖}}_{SP} \qquad ( 3 )$$

where the term labeled “SP” is a sharpness penalty term.

In more detail, the gradient of the sharpness penalty term reveals separate functional sharpness and logit sharpness paths to sharpness minimization.

$${∇}_{θ} SP ( θ ) := ρ \frac{\partial }{\partial θ} ‖ {∇}_{θ} ℒ ( θ ) ‖ = ( \frac{\partial }{\partial θ} {∇}_{\partial } ℒ ( θ ) ) \cdot {ϵ}^{\text{?}} ( θ ) \qquad ( 4 )$$

$$\text{?} \text{indicates text missing or illegible when filed}$$

In particular, the gradient can be decomposed, e.g., using the product rule, revealing a component gradient from logit perturbation and a component functional gradient.

$${\underbrace{[ {∇}_{θ} F ( θ ) \cdot \frac{\partial }{\partial θ} ( {∇}_{\text{?}} ℒ ( θ ) ) ] \cdot {ϵ}^{\text{?}} ( θ )}}_{SP gradient from logit perturbation := {δ}_{\text{?}}} + {\underbrace{[ \frac{\partial }{\partial θ} ( {∇}_{θ} ( F ( θ ) ) \cdot {∇}_{\text{?}} ℒ ( θ ) ] \cdot {ϵ}^{\text{?}} ( θ )}}_{SP gradient from perturbing the function Jacobian \text{?}} \qquad ( 5 )$$

$$\text{?} \text{indicates text missing or illegible when filed}$$

where F(θ) is the parameterization of the function provided by the set of parameter values 125 of the neural network model 120, the first term δ_{logit} represents the logit path to sharpness minimization, e.g., directly optimizing the sharpness through the effects of the logits on the loss function 150, and the second term δ_{functional} represents the functional path to sharpness minimization, e.g., optimizing the sharpness through modification of the functional Jacobian, the first derivative of the loss function 150 relative to the set of parameter values 125, e.g., the gradient 142.

For example, the sharpness-aware loss engine 140 can determine a functional sharpness perturbation vector ϵ_{functional} that optimizes a measure of functional sharpness. To target the functional path to sharpness minimization, the engine 140 can determine the perturbation vector 144 based on the maximal loss perturbation vector and a functional sharpness component of the gradient 142. By optimizing functional sharpness, the system 100 can promote the neural network model 120 learning simpler, more robust functions that generalize better to unseen data. An example for generating a functional sharpness perturbation vector is described with respect to FIG. 2.

As another example, the sharpness-aware loss engine 140 can determine a logit sharpness perturbation vector that optimizes a measure of logit sharpness. To target the logit path to sharpness minimization, the engine 140 can determine the perturbation vector 144 based on the maximal loss perturbation vector and a logit sharpness component of the gradient 142. In particular, by optimizing logit sharpness, the system 100 can reduce the sensitivity of the model's outputs to parameter perturbations. An example for generating a logit sharpness perturbation vector is described with respect to FIG. 2.

After determining the perturbation vector 144, the sharpness-aware loss engine 140 can apply the perturbation vector 144 to the set of parameter values 125 to generate the perturbed set of parameters 146. More specifically, the sharpness-aware loss engine 140 can apply the perturbation vector 144 to the set of parameter values 125 by adding the perturbation vector 144 with the set of parameter values 125: θ+ρϵ, where ρ are the locality parameters 160. In this context, the measure of sharpness is a local measure of sharpness in the neighborhood defined by the locality parameters 160, e.g., a local measure of functional sharpness or a local measure of logit sharpness.

In some cases, the perturbation radius defined by the locality parameters 160 can be adjusted in accordance with an objective function, e.g., the loss function 150 used to update the set of parameter values 125, to find an optimal balance between loss minimization and sharpness regularization. For example, the perturbation radius can be adjusted during earlier training iterations to balance stable loss minimization with effective regularization.

As another example, the system 100 can use layer-wise perturbation scaling, where different subsets of parameter values 125(a) are perturbed using different locality parameters 160, e.g., as specified by a vector ρ including multiple locality parameters 160. That is, the system can scale the perturbation vector using a set of one or more locality parameters 160, e.g., that each correspond with a respective subset of the set of parameter values of the neural network model. For example, the perturbation vector 144 can be scoped to specific layers, residual connections, or stream of residual connections within a Transformer architecture based on the locality parameters 160. In this case, the perturbation radius for each layer, residual connection, or stream specified by the vector ρ, can also be adjusted in accordance with an objective function. As another example, in the case that ρ includes some zero values, the engine 140 can apply, e.g., add, the perturbation vector 144 to only a proper subset of parameter values 125(a), e.g., based on the perturbation radius defined by the locality parameters 160.

The sharpness-aware loss engine 140 can then compute a sharpness-aware gradient 170. For example, the engine 140 can compute the sharpness-aware gradient 170 by evaluating the gradient of the loss function 150 with respect to the perturbed set of parameters 146. For example, the engine 140 can compute the sharpness-aware gradient 170 by processing the Jacobian of the model outputs at the perturbed set of parameters 146 and the derivative of the loss function 150 with respect to the outputs at the original parameters. As another example, the engine 140 can compute the sharpness-aware gradient 170 by determining a discrepancy between a target output for each of the set of training examples and the predicted output generated using the perturbed set of parameters 146.

The sharpness-aware training system 100 can update the set of parameter values 125 of the neural network model 120 in accordance with the sharpness-aware gradient 170. More specifically, the system 100 can train the neural network model 120 by calculating and backpropagating the sharpness-aware gradients 170 determined using the perturbed set of parameter values to update the set of parameter values of the neural network model, e.g., using the update rule of any appropriate gradient descent optimization algorithm, e.g., RMSprop, Adam, or AdamW.

By repeating this process over multiple training iterations, the system 100 can steer the neural network model 120 toward a region of the parameter space characterized by low functional sharpness or logit sharpness. That is, during each training iteration, the system 100 can update the set of parameter values 125 of the neural network model 120 in accordance with a sharpness-aware gradient 170 determined using either the functional sharpness perturbation vector or the logit sharpness perturbation vector. In some implementations, the sharpness-aware loss engine 140 is configured to determine only a functional sharpness perturbation vector, or only a logit sharpness perturbation vector at each of the training iterations. In other implementations, the sharpness-aware loss engine 140 is configured to alternate between determining a functional sharpness perturbation vector, or a logit sharpness perturbation vector, e.g., in accordance with a predefined learning schedule.

Since the update rule of any appropriate gradient descent optimization algorithm involves taking optimization steps along a loss landscape to find a local minimum, by perturbing the set of parameter values along a vector that optimizes a particular measure of sharpness, e.g., a functional or logic measure of sharpness, the system 100 can ensure that the update rule involves taking optimization steps to optimize the particular measure of sharpness. That is, determining a perturbation vector 144 that results in a perturbed set of parameters 146 that optimizes a particular measure of sharpness refers to determining a perturbation vector relative to a current update vector that can be followed to optimize, e.g., decrease, the particular measure of sharpness, e.g., either functional or logit sharpness, when applied to the set of parameter values 125.

After the training process is complete, the trained neural network model 120 can be deployed to an inference system. The inference system can receive a new input and process the new input using the trained set of parameter values 125 to generate a high-quality output. Because the model was trained to minimize functional sharpness, the generated output is more likely to be accurate even when the new input differs slightly from the data distribution seen during training.

Thus, the sharpness-aware training system 100 can be used to train robust neural network models for a variety of downstream applications. In more detail, the system 100 can train neural network models 120 that demonstrate improved validation metrics and better generalization capabilities across various scales, from small models to billion-parameter scale LLMs.

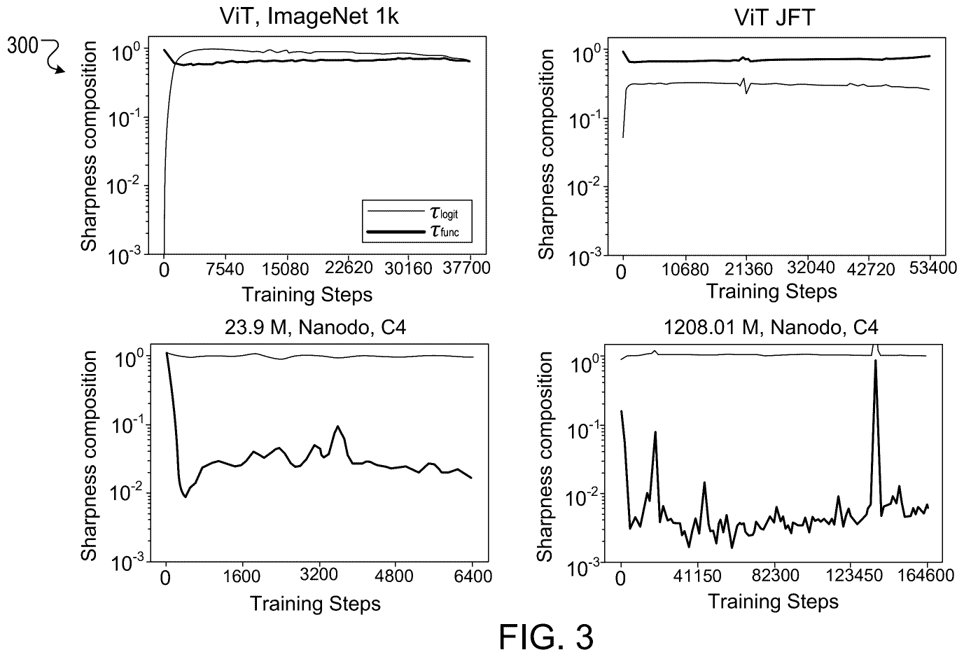

In particular, the system 100 can promote the robust training of language models, where sharpness-aware minimization does not generally perform well, since the logit path to sharpness minimization tends to overwhelm the functional path, e.g., as is depicted and described in more detail with respect to FIG. 3. For example, a language model trained by the system 100 can be used for text generation, summarization, or translation with higher fidelity. Similarly, a vision transformer model trained by the system 100 can demonstrate improved robustness to distribution shifts in image classification or object detection tasks.

FIG. 2 is a block diagram of an example sharpness-aware loss engine. For example, the sharpness-aware loss engine 140 of FIG. 1 can be implemented as the sharpness-aware loss engine 200 of FIG. 2.

As is described with respect to FIG. 1, the sharpness-aware loss engine 200 can determine a maximal loss perturbation vector 210 as an approximation of the optimal perturbation ϵ*, defined by Equation 2, at each of a number of training iterations. In more detail, the sharpness-aware loss engine 200 can determine the maximal loss perturbation vector 210 as a perturbation vector that points in the direction of the steepest local increase in loss within the neighborhood defined by the locality parameters 270. The sharpness-aware loss engine 200 can also compute a gradient 220, e.g., based on the first derivative of the loss function relative to the set of parameters at the current iteration.

The sharpness-aware loss engine 200 can determine a functional sharpness perturbation vector 242 or a logit sharpness perturbation vector 244 as the perturbation vector 240 using the maximal loss perturbation vector 210 and the gradient 220 in a variety of ways.

For example, the sharpness-aware loss engine 200 can determine a functional sharpness perturbation vector 242 along a direction that optimizes the functional sharpness by decomposing the maximal loss perturbation vector 210 along the functional path to sharpness minimization. In particular, the engine 200 can identify the functional sharpness component 222 of the gradient 220, e.g., by isolating the derivative of the component of the gradient 220 that relates to functional sharpness:

$$\frac{\partial }{\partial θ} ( {∇}_{θ} F ( θ ) ) .$$

More specifically, the engine 200 can identify a functional sharpness component of the gradient 220 using the Hessian of the loss function relative to the current set of parameter values. In this context, the Hessian refers to the second derivative of the loss function 150 relative to the set of parameter values 125 for the current iteration: H_{L}=∇²_{θ} L. For example, the engine 200 can decompose the Hessian of the loss function using a Gauss-Newton Decomposition of the Hessian, e.g., as is described in more detail in N. N. Schraudolph. “Fast curvature matrix-vector products for second-order gradient descent. Neural Computation, 14:1723-1738, 2002.

The functional sharpness component of the gradient 142 relates to the curvature of the function implemented by the neural network model 120, e.g., as represented by a functional component of the Gauss-Newton Decomposition of the Hessian. In some cases, the engine 200 can approximate an optimization of a measure of functional sharpness using a derivative of the outputs for the inputs, e.g., the Jacobian matrix. For example, the functional component 242 of the sharpness gradient can be determined by computing a perturbed Jacobian:

$$- {∇}_{θ} F ( θ + {ρϵ}^{*} ) . \qquad ( 6 )$$

The engine 200 can then process the functional sharpness component 222 and the maximal loss perturbation vector 210 using a projection subsystem 230 to project the maximal loss perturbation vector 210 along the direction specified by the functional sharpness component 222 of the gradient 220. The projection subsystem 230 can project the maximal loss perturbation vector 210 along specific directions, e.g., in accordance with a functional/logit indicator 235 that defines whether to project the maximal loss perturbation vector 210 along the functional or logit directions.

As a related example, the sharpness-aware loss engine 200 can determine a logit sharpness perturbation vector 244 along a direction that optimizes the logit sharpness by decomposing the maximal loss perturbation vector 210 along the logit path to sharpness minimization. In particular, the engine 200 can identify the respective logit sharpness component 224 of the gradient 220 that relates to the measure of logit sharpness, e.g., by identifying the derivative of the component of the gradient 220 that relates to logit sharpness:

$$\frac{\partial }{\partial θ} ( {∇}_{\text{?}} ℒ ( θ ) )$$

$$\text{?} \text{indicates text missing or illegible when filed}$$

More specifically, the engine 200 can identify a logit sharpness component of the gradient 220 using the Hessian of the loss function, e.g., as described above. In this case, the logit sharpness component of the gradient 142 relates to the linearized curvature implemented by the neural network model 120, e.g., as represented by the Generalized Gauss Newton component of the Gauss-Newton Decomposition of the Hessian. In some cases, the engine 200 can approximate an optimization of a measure of logit sharpness using a derivative of the outputs for the inputs, e.g., the Jacobian matrix. For example, the logit component 244 of the sharpness gradient can be determined by computing a derivative of the loss function with respect to the perturbed logits:

$$- {∇}_{F} ℒ ( θ + {ρϵ}^{*} ) \qquad ( 7 )$$

The engine 200 can then process the logit sharpness component 224 and the maximal loss perturbation vector 210 using the projection subsystem 230, as described above, to project the maximal loss perturbation vector 210 along the direction specified by the logit sharpness component 224 of the gradient 220.

In the particular example depicted, the projection subsystem 230 receives a functional/logit indicator 235 as a control signal, e.g., to indicate whether to project the maximal loss perturbation vector 210 along the direction of functional or logit sharpness at each training iteration. The functional/logit indicator 235 determines the selection of a particular sharpness pathway, e.g., at each training iteration. In particular, the loss engine 200 can use the functional/logit indicator 235 to determine whether the sharpness-aware loss engine 200 should prioritize the functional path, the logit path, or an interpolation of both. For example, for natural language processing tasks that tend to favor the logit pathway, the indicator 235 can be preset to prioritize the functional path.

For example, the subsystem 230 can determine whether to optimize the measure of logit sharpness or functional sharpness based on the magnitude of the functional sharpness component 222 of the gradient 220, the magnitude of the logit sharpness component 224 of the gradient 220 that relates to the measure of logit sharpness, or the correlation between the magnitudes of the respective components 222 and 224.

In some cases, the functional/logit indicator 235 provides for the interpolation between the functional and logit paths to sharpness minimization over the training iterations using an angle φ that defines the relative contributions of the functional paths using a sinusoidal relationship. For example, the loss engine can determine the perturbation vector 240 as sin(φ) (functional sharpness perturbation vector 242)+cos (φ) (logit sharpness perturbation vector 244). In this case, in the case that φ=0, the projection subsystem 230 can determine the perturbation vector 240 as the functional sharpness perturbation vector 242, and in the case that φ=π/2, the projection subsystem 230 can determine the perturbation vector 240 as the logit sharpness perturbation vector 244. In this context, the projection subsystem 230 can achieve the perturbation of the Sharpness Aware Minimization (Foret, P., et. al.) in the case that φ=π/4.

As another example, the sharpness-aware loss engine 200 can determine values of a preconditioning matrix 205 M⁻¹(θ) in accordance with eliminating a component of the maximal loss perturbation vector 210, and can apply the preconditioning matrix 205 to the maximal loss perturbation vector 210 to determine the perturbation vector 240. In this context, applying the preconditioning matrix to the maximal loss perturbation vector can refer to determining a dot product between the preconditioning matrix and the maximal loss perturbation vector, e.g., μM⁻¹(θ)ϵ″(θ).

For example, the loss engine 200 can eliminate the component that relates to optimizing the measure of logit sharpness to determine a functional sharpness perturbation vector 242. As another example, the loss engine 200 can eliminate the component that relates to optimizing the measure of functional sharpness to determine the logit sharpness perturbation vector 244.

In either case, the loss engine 200 can determine the values of the preconditioning matrix by bootstrapping values of the preconditioning matrix 205 using diagonal preconditioning of an approximation of a second moment of the gradient 220, e.g., the Hessian. For example, rather than computing the full Hessian, the loss engine 200 can receive the second moment of the gradient 220 from the optimizer that the training system is using to update the set of parameter values of the neural network model at each iteration. More specifically, the loss engine 200 can precondition by the inverse of the component of the second moment of the gradient 220 to be eliminated, e.g., preconditioning by the inverse of the logit component of the second moment of the gradient 220 results in up-weighing the functional component, and preconditioning by the inverse of the functional component of the second moment of the gradient 220 can result in up-weighing the logit component.

As an example, in the case that the preconditioning matrix 205 is used to eliminate the component that relates to the measure of logit sharpness when training a transformer-based language model, the preconditioning matrix 205 can alleviate heterogeneity across different modules of the neural network model 120 and suppress spurious logit manipulation. Furthermore, the use of preconditioning can allow a training system, e.g., the training system 100, to improve the stability of the training process and reduces the likelihood of numerical instabilities, such as the generation of NaNs, during large-scale training, e.g., of deep Transformer networks.

As yet another example, the loss engine 200 can combine the projection and the preconditioning matrix 205. In more detail, the loss engine 200 can identify either the (i) functional sharpness, or (ii) logit sharpness component vector using the Hessian of the loss, as described above relative to the projection subsystem 230, and can additionally apply the corresponding preconditioning matrix 205 determined in accordance with eliminating the other component, e.g., by eliminating the logit sharpness component for the functional sharpness optimization or by eliminating the functional sharpness component for the logit sharpness optimization, to generate the perturbation vector 240.

After determining the perturbation vector 240, the loss engine 200 can apply the perturbation vector 240 to the set of parameters (not depicted) to generate the perturbed set of parameters 250. In particular, the sharpness-aware loss engine 140 can add the perturbation vector 144 with the set of parameter values: θ+ρϵ, where ρ are the locality parameters 160. As described with respect to FIG. 1, in some cases, e.g., in the case that ρ is a vector including some zeros that correspond with a particular subset of the parameter values, the loss engine 200 can apply the perturbation vector 240 to the remaining proper subset of the set of parameters.

The loss engine 200 can then compute a sharpness-aware gradient 260. In particular, the loss engine 200 can compute a maximal loss gradient of the set of perturbed parameter values using the perturbed set of parameter values. In this case, the loss engine 200 can generate an approximation of the sharpness-aware gradient 260 of the loss function with respect to the perturbed set of parameter values by applying a derivative of the loss function with respect to the outputs to the maximal loss gradient.

For example, the engine 140 can compute the sharpness-aware gradient 170 by processing the Jacobian of the model outputs at the perturbed set of parameters 146 and the derivative of the loss function 150 with respect to the outputs at the original parameters. In some cases, the loss engine 200 can compute a vector Jacobian product of the quantity of Equation 6 by the derivative of the loss with respect to the outputs, e.g., relative to the set of unperturbed parameters, to determine a sharpness-aware gradient 260 that optimizes the measure of functional sharpness.

An example Python implementation for computing a vector Jacobian product of the quantity of Equation 6 by the derivative of the loss with respect to the outputs is provided below.

```
from jax import grad , vjp
from jax. tree_util import tree_map
from utils import normalize_grad
def functional_sam_gradients (params , loss_fn , network_fn , rho):
  # compute the usual loss gradient , but also extract dL_dlogits
  ( dL_dlogits ), dL_dtheta = grad ( loss_fn , hax_aux = True )( params )
  # normalize the gradients
  dL_dtheta = normalize_grad ( dL_dtheta )
  # perturb the parameters
  perturbed_params = tree_map ( lambda a, b: a + rho * b, params , dL_dtheta)
  # set up the VJP at the perturbed parameters
  _, dF_dtheta_fn = vjp ( lambda theta : network_fn ( theta ), perturbed_params)
  # do the VJP with the ( unperturbed ) dL_dlogits
  functional_sam_grad = dF_dtheta_fn ( dL_dlogits )[0]
  return functional_sam_grad
```

In this example implementation, the function calculates a gradient that targets only the functional path to sharpness minimization, e.g., effectively discarding the logit component, by computing a vector Jacobian product where the Jacobian is perturbed, but the loss derivative is fixed. In this case, the effect of perturbation resides only in the functional Jacobian part. In more detail, the code first computes the derivative of the loss with respect to the outputs, dL_dlogits, using the original unperturbed parameters params. The code then computes a vector Jacobian product dF_dtheta_fn using the perturbed parameters perturbed_params which corresponds to the Jacobian of the function evaluated at the perturbed parameters, and computes the product of the perturbed Jacobian and the unperturbed loss derivative to isolate the functional sharpness component functional_sam_grad.

As another example, the engine 140 can compute the sharpness-aware gradient 170 by determining a discrepancy between a target output for each of the set of training examples and the predicted output generated using the perturbed set of parameters 146. In some cases, the loss engine 200 can compute a vector Jacobian product of the quantity of Equation 7 by the Jacobian, e.g., the Jacobian evaluated at the set of unperturbed parameters, to determine a sharpness-aware gradient 260 that optimizes the measure of logit sharpness.

The loss engine 200 can then provide the sharpness-aware gradient 260 to a training system, thereby allowing the training system to update the set of parameter values of the neural network model at the current training iteration in accordance with optimizing a particular type of sharpness. Thus, the sharpness-aware loss engine 200 allows for tailored sharpness optimization along either the functional or logit pathways to sharpness minimization.

FIG. 3 depicts the difference between the functional sharpness path and the logit sharpness path for four different transformer models. More specifically, the plot 300 illustrates the observed technical characteristics of the decomposed gradient of the sharpness penalty term of Equation 5 across various neural network architectures and data domains.

The plots 300 depict normalized sharpness contributions τ_{logit}, represented by a blue line, and τ_{functional}, represented by an orange line. These contributions correspond to the relative contributions of the logit component δ_{logit} and the functional component δ_{functional} of Equation 5, e.g.,

$${τ}_{logit} = \frac{{‖ {δ}_{logit} ‖}^{2}}{{‖ {∇}_{θ} SP ‖}^{2}} , {τ}_{func} = \frac{{‖ {δ}_{func} ‖}^{2}}{{‖ {∇}_{θ} SP ‖}^{2}} ,$$

$${τ}_{cross} = 2 \frac{〈 {δ}_{logit} , {δ}_{func} 〉}{{‖ {∇}_{θ} SP ‖}^{2}}$$

In particular, the relative values can illustrate whether sharpness minimization will prioritize reduction of logit sharpness more or that of functional sharpness, as well as how correlated they are by looking at the cross term.

As shown in the top subplots for Vision Transformer (ViT) models on ImageNet-1K and JFT datasets, the logit path and functional path contributions are balanced. In contrast, the bottom subplots illustrate a logit-path dominance for Nanodo models processing a natural language processing (NLP) dataset (C4). In these natural language processing implementations, the normalized logit contribution τ_{logit} frequently approaches a value of 1.0, while the normalized functional contribution τ_{functional} remains significantly lower.

The plots 300 further illustrate a path antagonism characterized by a negative cross-contribution τ_{cross}, e.g., as seen in the relative positions of the curves. In particular, the negative cross-contribution indicates that updates targeting logit sharpness can move the parameter values in a direction that opposes functional sharpness minimization. This observed imbalance motivates the selective sharpness minimization of the sharpness-aware loss engine 140 and 200, e.g., to prioritize the functional path in Nanodo. Furthermore, the plots demonstrate that this imbalance persists at a billion-parameter scale (e.g., 1208.01 M), indicating a technical requirement for functional-sharpness targeting in large-scale generative models.

As shown in the top subplots for Vision Transformer (ViT) models on ImageNet-1K and JFT datasets, the logit path and functional path contributions are relatively balanced. In contrast, as shown in the bottom subplots for Nanodo models on the C4 natural language processing (NLP) dataset, the logit path and the functional path to sharpness minimization are unaligned and in a state of mutual opposition. That is, the logit path τ_{logit} dominates the sharpness gradient, frequently approaching a value of 1.0, while the functional path τ_{functional} remains significantly lower. In this case, the dominant logit path prevents the minimization of the functional path, thereby reducing generalization capabilities.

This observed imbalance between the functional and logit path to sharpness minimization indicates that in certain domains, such as NLP, standard sharpness minimization techniques are biased toward reducing logit sharpness, which can lead to over-confidence in model predictions. These empirical observations motivate a need to selectively prioritize the functional path to sharpness minimization, in some cases, to improve generalization of transformer-based language models. Furthermore, the plots 300 illustrate that this imbalance persists at the billion-parameter scale (e.g., 1208.01 M), indicating the technical necessity of functional-sharpness targeting for large-scale generative models. In particular, by tailoring the training using a functional sharpness perturbation vector rather than total loss landscape sharpness, the sharpness-aware training system 100 can avoid spurious logit manipulation that can degrade performance in language modeling tasks, as depicted in FIG. 3.

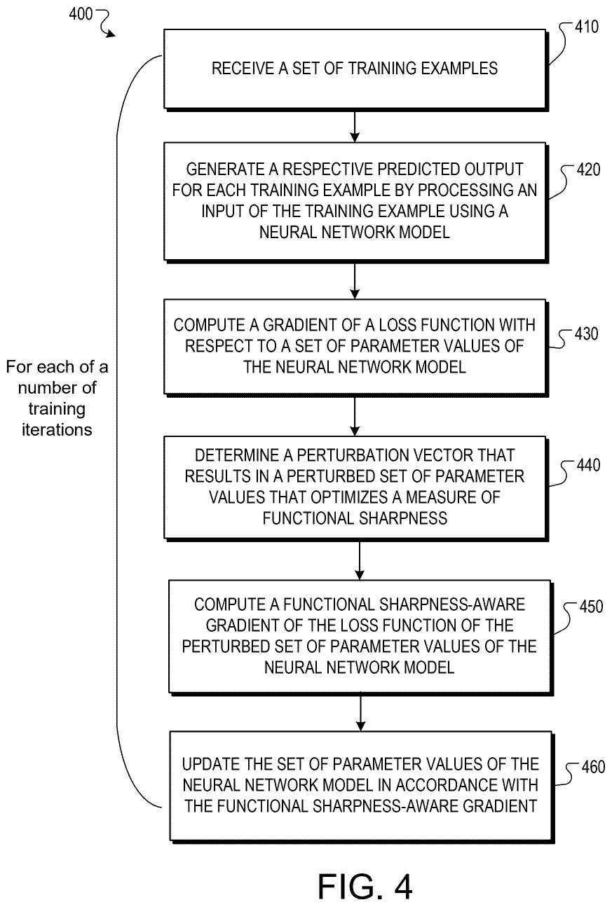

FIG. 4 is a flow diagram of an example process 400 for training a neural network to optimize a measure of functional sharpness at each of a number of training iterations. For convenience, the process 400 will be described as being performed by a system of one or more computers located in one or more locations.

For example, a training system, e.g., the sharpness-aware training system 100 of FIG. 1, appropriately programmed in accordance with this specification, can perform the process 400 at each of a number of training iterations. In some cases, the system can determine whether to update the neural network model using a measure of functional sharpness. For example, the system can determine whether to update the neural network using a measure of logit sharpness or a measure of functional sharpness based on one or more of a magnitude of a derivative of a functional sharpness component of the gradient of the outputs of the neural network at a current iteration, a magnitude of a derivative of the logit sharpness component of the gradient at the current iteration, or a measure of correlation between the magnitude of the derivative of the functional sharpness component and the magnitude of the derivative of the logit sharpness component. In response to determining that the neural network should be updated using a measure of functional sharpness, the system can perform the process 400.

The system can receive a set of training examples (step 410). Each training example can include an input and a target output. Generally, the set of training examples can correspond with a particular neural network training task. In some cases, the system can be used to train a generative neural network on a next token prediction task. In other cases, the system can be used to train a computer vision model on a computer vision task.

The system can generate a respective predicted output for each training example by processing an input of the training example using a neural network model (step 420). In particular, the system can generate a respective predicted output by processing the input of the training example in accordance with a set of parameter values of the neural network model, e.g., the set of parameter values at the current training iteration.

For example, the neural network model can be a generative neural network e.g., that is being trained to perform a next token prediction task. In some cases, the generative neural network is a multi-modal generative neural network, e.g., that is configured to process inputs that include two or more of text, audio, images, or videos, and that is configured to generate an output that includes two or more of text, audio, images, or videos. As another example, the neural network model can be a computer vision model, e.g., that is being trained for a computer vision task.

The system can compute a gradient of a loss function using the respective predicted outputs for the inputs (step 430). In particular, the system can compute the gradient of the loss function with respect a set of parameter values of the neural network model, e.g., the set of parameter values at the current training iteration.

The system can determine a perturbation vector that results in a perturbed set of parameter values that optimizes a measure of functional sharpness (step 440). For example, the measure of functional sharpness can measure a tendency of the respective predicted outputs for each of the inputs to change when the set of parameter values are perturbed. In particular, the system can determine the perturbation vector using the gradient, and can apply the perturbation vector to the set of parameter values to generate the perturbed set of parameter values. In this context, applying the perturbation vector can refer to adding the perturbation vector to the set of parameter values to generate the perturbed set of parameter values.

In some implementations, the system can identify a maximal loss perturbation vector that approximates a perturbation vector that results in a perturbed set of parameter values that maximizes the loss function, and can identify a particular component of the gradient that relates to the measure of functional sharpness. For example, the maximal loss perturbation vector can be a maximal local loss perturbation vector that is determined within a neighborhood defined by a locality parameter, and the measure of functional sharpness can be a local measure of functional sharpness in the neighborhood defined by the locality parameter. In this case, the system can generate the perturbation vector by projecting the maximal loss perturbation vector along a direction that optimizes the measure of functional sharpness using a derivative of the particular component of the gradient.

In some cases, the system can determine values of a preconditioning matrix in accordance with eliminating a component of the maximal loss perturbation vector that relates to optimizing a measure of logit sharpness, and prior to generating the perturbation vector by projecting the maximal loss perturbation vector along a direction that optimizes the measure of functional sharpness, the system can apply the preconditioning matrix to the maximal loss perturbation vector. In this context, applying the preconditioning matrix to the maximal loss perturbation vector can refer to determining a dot product between the preconditioning matrix and the maximal loss perturbation vector. For example, the system can determine the values of the preconditioning matrix by bootstrapping values of the preconditioning matrix using diagonal preconditioning of an approximation of a second moment of the first gradient.

In other implementations, the system can identify a maximal loss perturbation vector that approximates a perturbation vector that results in a perturbed set of parameter values that maximizes the loss function, and can determine values of a preconditioning matrix in accordance with eliminating a component of the maximal loss perturbation vector that relates to optimizing a measure of logit sharpness. In this case, the system can apply the preconditioning matrix to the maximal loss perturbation vector to generate the perturbation vector. For example, the system can determine the values of the preconditioning matrix by bootstrapping values of the preconditioning matrix using diagonal preconditioning of an approximation of a second moment of the first gradient.

In yet another implementation, the system can identify a maximal loss perturbation vector that approximates a perturbation vector that results in a perturbed set of parameter values that maximize the loss function, and can apply, e.g., add, the maximal loss perturbation to the set of parameter values to generate the perturbed set of parameter values.

In some cases, the system can scale the maximal loss perturbation vector using a set of one or more locality parameters. In this case, each locality parameter in the set of locality parameters can correspond with a respective subset of the set of parameter values of the neural network model, e.g., different layers of the neural network model. As an example, each of the set of one or more locality parameters can be tunable in accordance with an objective function. More specifically, the system can scale the maximal loss perturbation vector, e.g., prior to generating the perturbation vector by projecting the maximal loss perturbation vector along the direction that maximizes the measure of functional sharpness, to ensure that no single layer's perturbation dominates or destabilizes the training process.

After determining the perturbation vector, the system can apply the perturbation vector to the set of parameter values, e.g., by adding the perturbation vector with the set of parameter values. For example, the system can apply the perturbation vector to only a proper subset of the set of parameter values. In particular, the perturbation vector can be applied to specific layers or sub-units of the neural network model architecture based on the locality parameters.

The system can then compute a functional sharpness-aware gradient of the loss function of the perturbed set of parameter values of the neural network model (step 450). In particular, the system can compute the gradient of the loss function with respect to the perturbed set of parameter values using the respective predicted outputs for the inputs. In the case that the system directly applies the maximal loss perturbation vector to the set of parameter values, the system can compute a maximal loss gradient of the set of perturbed parameter values using the perturbed set of parameter values, and can generate an approximation of the second gradient by applying a derivative of the loss function with respect to the outputs to the maximal loss gradient.

The system can update the set of parameter values of the neural network model in accordance with the functional sharpness-aware gradient (step 460). In particular, the system can backpropagate the functional sharpness-aware gradients to update parameter values of the neural network model, e.g., using the update rule of any appropriate gradient descent optimization algorithm, e.g., RMSprop or Adam.

After training, the system can provide the neural network model to an inference system. For example, the inference system can receive a new input, and can process the new input using the neural network model to generate a new output for the new input.

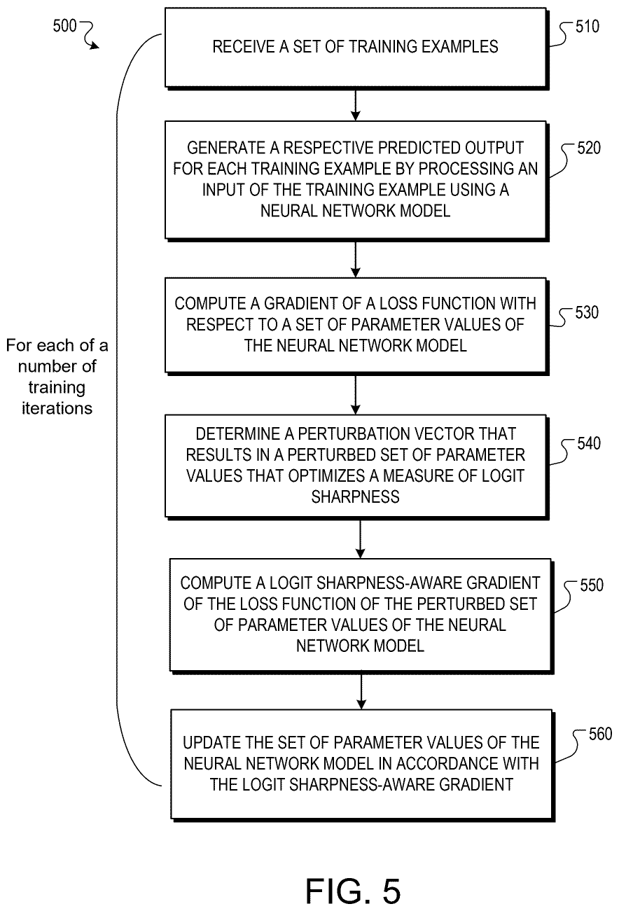

FIG. 5 is a flow diagram of an example process 500 for training a neural network to optimize a measure of logit sharpness at each of a number of training iterations. For convenience, the process 500 will be described as being performed by a system of one or more computers located in one or more locations.

For example, a training system, e.g., the sharpness-aware training system 100 of FIG. 1, appropriately programmed in accordance with this specification, can perform the process 500 at each of a number of training iterations. In some cases, the system can determine whether to update the neural network model using a measure of logit sharpness. For example, the system can determine whether to update the neural network using a measure of logit sharpness or a measure of functional sharpness based on one or more of a magnitude of a derivative of a functional sharpness component of the gradient of the outputs of the neural network at a current iteration, a magnitude of a derivative of the logit sharpness component of the gradient at the current iteration, or a measure of correlation between the magnitude of the derivative of the functional sharpness component and the magnitude of the derivative of the logit sharpness component. In response to determining that the neural network should be updated using a measure of logit sharpness, can system can perform the process 500.

The system can receive a set of training examples (step 510). Each training example can include an input and a target output. Generally, the set of training examples can correspond with a particular neural network training task. In some cases, the system can be used to train a generative neural network on a next token prediction task. In other cases, the system can be used to train a computer vision model on a computer vision task.

The system can generate a respective predicted output for each training example by processing an input of the training example using a neural network model (step 520). In particular, the system can generate a respective predicted output by processing the input of the training example in accordance with a set of parameter values of the neural network model, e.g., the set of parameter values at the current training iteration.

For example, the neural network model can be a generative neural network e.g., that is being trained to perform a next token prediction task. In some cases, the generative neural network is a multi-modal generative neural network, e.g., that is configured to process inputs that include two or more of text, audio, images, or videos, and that is configured to generate an output that includes two or more of text, audio, images, or videos. As another example, the neural network model can be a computer vision model, e.g., that is being trained for a computer vision task.

The system can compute a gradient of a loss function using the respective predicted outputs for the inputs (step 530). In particular, the system can compute the gradient of the loss function with respect a set of parameter values of the neural network model, e.g., the set of parameter values at the current training iteration.

The system can determine a perturbation vector that results in a perturbed set of parameter values that optimizes a measure of logit sharpness (step 440). For example, the measure of logit sharpness can be indicative of a tendency of logits used in calculating the loss function to change when the set of parameter values are perturbed. In particular, the system can determine the perturbation vector using the gradient, and can apply the perturbation vector to the set of parameter values to generate the perturbed set of parameter values. In this context, applying the perturbation vector can refer to adding the perturbation vector to the set of parameter values to generate the perturbed set of parameter values.

In some implementations, the system can identify a maximal loss perturbation vector that approximates a perturbation vector that results in a perturbed set of parameter values that maximizes the loss function, and can identify a particular component of the gradient that relates to the measure of logit sharpness. For example, the maximal loss perturbation vector can be a maximal local loss perturbation vector that is determined within a neighborhood defined by a locality parameter, and the measure of logit sharpness can be a local measure of logit sharpness in the neighborhood defined by the locality parameter. In this case, the system can generate the perturbation vector by projecting the maximal loss perturbation vector along a direction that optimizes the measure of logit sharpness using a derivative of the particular component of the gradient.

In some cases, the system can scale the maximal loss perturbation vector using a set of one or more locality parameters. In this case, each locality parameter in the set of locality parameters can correspond with a respective subset of the set of parameter values of the neural network model, e.g., different layers of the neural network model. As an example, each of the set of one or more locality parameters can be tunable in accordance with an objective function. More specifically, the system can scale the maximal loss perturbation vector, e.g., prior to generating the perturbation vector by projecting the maximal loss perturbation vector along the direction that maximizes the measure of logit sharpness, to ensure that no single layer's perturbation dominates or destabilizes the training process.

After determining the perturbation vector, the system can apply the perturbation vector to the set of parameter values, e.g., by adding the perturbation vector with the set of parameter values. For example, the system can apply the perturbation vector to only a proper subset of the set of parameter values. In particular, the perturbation vector can be applied to specific layers or sub-units of the neural network model architecture based on the locality parameters.

The system can then compute a logit sharpness-aware gradient of the loss function of the perturbed set of parameter values of the neural network model (step 450). In particular, the system can compute the gradient of the loss function with respect to the perturbed set of parameter values using the respective predicted outputs for the inputs.

The system can update the set of parameter values of the neural network model in accordance with the logit sharpness-aware gradient (step 460). In particular, the system can backpropagate the logit sharpness-aware gradients to update parameter values of the neural network model, e.g., using the update rule of any appropriate gradient descent optimization algorithm, e.g., RMSprop or Adam.

After training, the system can provide the neural network model to an inference system. For example, the inference system can receive a new input, and can process the new input using the neural network model to generate a new output for the new input.

After training, the system or another inference system can deploy the trained neural network model for performing a machine learning task. In general, the above techniques can be used to implement and customize a wide range of machine learning tasks.

For example in some implementations the generative neural network may implement a sequence-to-sequence model that processes an input sequence of tokens to provide an output sequence of tokens, e.g., from a vocabulary of tokens. For example the tokens may comprise tokens representing text such as words or wordpieces in a natural language, or values or acoustic features of an audio waveform, or values of pixels of a still or moving image (which as used herein includes points of a LIDAR point cloud). In some implementations the context input may comprise tokens representing observations of an environment, e.g., a real world environment, of an agent, e.g., a mechanical agent, and the output example may include tokens that represent actions to be performed by the agent. In some implementations one or both of the context input and the output example comprise data in some other format. For example the context input may comprise an embedding of one or more of the aforementioned data types; and the output example may comprise data representing, e.g., text, audio, image pixels, or actions that is not tokenized.

Where the neural network model comprises a language model neural network the context input may represent a sequence of text in one language and the output example can be a translation of the sequence of text into another language, i.e., a sequence of text in the other language that is a translation of the input sequence of text. In some implementations the neural network model may be trained to perform a multi-lingual machine translation task, i.e., to translate between multiple different source language—target language pairs (in which case the context input may be augmented with an identifier that indicates the target language).

In some implementations the neural network model comprises a language model neural network models a computer language, e.g., an interpreted or complied high level language, or a markup language, or machine code. The context input may represent a sequence of text in the computer language, i.e., computer code, e.g., a computer program, and the output example may represent a sequence of text in a natural language that describes the operation of the code; or the context input may represent a sequence of text in a natural language that specifies the operation of a computer program or other computer code, and the output example may represent a sequence of text in the computer language, i.e., computer code, that operates as specified.

In some applications the neural network model comprises an audio, image or video generation model or a multimodal model. The output example may then comprises one or both of audio data representing an audio waveform and image data representing pixels of a still or moving image. The context input may defines characteristics of the output example, e.g., describing the output example to be generated. For example the context input may comprise text in a natural language, e.g., as a sequence of tokens, that defines, e.g., describes, a target content of the output example such as an image, audio, or video to be generated. Or context input may comprise an image, audio, or video, and the output example may describe one or more characteristics of the context input.

Where the context input comprises text in a natural language the output example may comprise audio data that represents a spoken utterance of the text in the natural language. As another example, where the context input comprises audio data, e.g., a sequence of tokens, for a spoken utterance in a natural language the output example may represent text, e.g., as a sequence of tokens, that is a transcription of the spoken utterance in the natural language.

The neural network model may comprise a multimodal model, that is configured to process a context input and/or generate an output example that includes data of multiple different types, e.g., two or more of data representing text in a natural language, audio, still or moving images, observations of an environment, and actions for an agent, e.g., represented as tokens as previously described. Such a multimodal model may, e.g., convert between different input and output modes, e.g., text/image/audio, e.g., for captioning, or otherwise classifying (into one of a set of classes) or characterizing an image or audio input, or by answering a question related to the image or audio input, e.g., relating to a future, e.g., a physical prediction of a state of objects represented by the image or audio, or by generating data representing an image or audio in answer to a text, audio, or visual question represented by the context input.

The neural network model may comprise a neural network configured to perform an agent control task.

For example, the context input may comprise data, e.g., tokens, that represent a sequence of one or more observations characterizing states of an environment, and the output example may comprise data that defines an action to be performed by the agent in response to the most recent data in the sequence.

As one example, the agent may be a mechanical agent, e.g., a robot, acting in a real-world environment to perform a task; the observations may comprise any type of observations, e.g., observations from one or more sensors of the environment, such as an image sensor or a sensor of a position, state or configuration of the agent. The output example may comprise control signals, e.g., tokens that represent control signals, used to control the agent to perform the task, e.g., to control position, velocity, or acceleration of the agent, e.g., for navigation, or of parts of the agent, e.g., for object manipulation. Optionally the context input may include other information, e.g., textual tokens for text defining the task to be performed. Such a task may be, e.g., to locate or manipulate an object of interest in the environment or to move an object of interest to a specified location in the environment or to navigate to a specified destination in the environment. In another example the agent may be a human agent and the actions may comprise instructions, e.g., actions that generate text, audio, and/or visual instructions, to the human to perform the task. For example a digital assistant may include one or more sensors such as a camera that capture observations of the human user, and can use the generative neural network to generate actions in response to the observations, e.g., action tokens, that represent instructions to the user to perform a particular task, to guide the user through the task. The task may, e.g., be defined by text in a natural language in the context input, e.g., encoded as text tokens.

As another example, the agent may be a simulated agent acting in a simulated environment. That is, the environment may be a simulated environment, e.g., a video game or a simulator of a real-world environment, generated by one or more software programs and the agent may be a simulated agent interacting within the simulated environment.

As another example, the agent may be a computer control agent that controls one or more software applications executing on one or more computers. For example, the agent can perform actions that are commands for interacting with the one or more software applications. The software applications can be, e.g., applications on smartphones, tablets, or other mobile devices, applications on a different type of user computer, or application executing one on or more server computers. The commands can be, e.g., virtual input device commands, e.g., virtual mouse or keyboard commands, or calls to an application programming interface (API) or a combination of the two.

In this specification, the term “configured” is used in relation to computing systems and environments, as well as computer program components. A computing system or environment is considered “configured” to perform specific operations or actions when it possesses the necessary software, firmware, hardware, or a combination thereof, enabling it to carry out those operations or actions during operation. For instance, configuring a system might involve installing a software library with specific algorithms, updating firmware with new instructions for handling data, or adding a hardware component for enhanced processing capabilities. Similarly, one or more computer programs are “configured” to perform particular operations or actions when they contain instructions that, upon execution by a computing device or hardware, cause the device to perform those intended operations or actions.

The embodiments and functional operations described in this specification can be implemented in various forms, including digital electronic circuitry, software, firmware, computer hardware (encompassing the disclosed structures and their structural equivalents), or any combination thereof. The subject matter can be realized as one or more computer programs, essentially modules of computer program instructions encoded on a tangible non-transitory storage medium for execution by or to control the operation of a computing device or hardware. The storage medium can be a storage device such as a hard drive or solid-state drive (SSD), a storage medium, a random or serial access memory device, or a combination of these. Additionally or alternatively, the program instructions can be encoded on a transmitted signal, such as a machine-generated electrical, optical, or electromagnetic signal, designed to carry information for transmission to a receiving device or system for execution by a computing device or hardware. Furthermore, implementations may leverage emerging technologies like quantum computing or neuromorphic computing for specific applications, and may be deployed in distributed or cloud-based environments where components reside on different machines or within a cloud infrastructure.

The term “computing device or hardware” refers to the physical components involved in data processing and encompasses all types of devices and machines used for this purpose. Examples include processors or processing units, computers, multiple processors or computers working together, graphics processing units (GPUs), tensor processing units (TPUs), and specialized processing hardware such as field-programmable gate arrays (FPGAs) or application-specific integrated circuits (ASICs). In addition to hardware, a computing device or hardware may also include code that creates an execution environment for computer programs. This code can take the form of processor firmware, a protocol stack, a database management system, an operating system, or a combination of these elements. Embodiments may particularly benefit from utilizing the parallel processing capabilities of GPUs, in a General-Purpose computing on Graphics Processing Units (GPGPU) context, where code specifically designed for GPU execution, often called kernels or shaders, is employed. Similarly, TPUs excel at running optimized tensor operations crucial for many machine learning algorithms. By leveraging these accelerators and their specialized programming models, the system can achieve significant speedups and efficiency gains for tasks involving artificial intelligence and machine learning, particularly in areas such as computer vision, natural language processing, and robotics.

A computer program, also referred to as software, an application, a module, a script, code, or simply a program, can be written in any programming language, including compiled or interpreted languages, and declarative or procedural languages. It can be deployed in various forms, such as a standalone program, a module, a component, a subroutine, or any other unit suitable for use within a computing environment. A program may or may not correspond to a single file in a file system and can be stored in various ways. This includes being embedded within a file containing other programs or data (e.g., scripts within a markup language document), residing in a dedicated file, or distributed across multiple coordinated files (e.g., files storing modules, subprograms, or code segments). A computer program can be executed on a single computer or across multiple computers, whether located at a single site or distributed across multiple sites and interconnected through a data communication network. The specific implementation of the computer programs may involve a combination of traditional programming languages and specialized languages or libraries designed for GPGPU programming or TPU utilization, depending on the chosen hardware platform and desired performance characteristics.

In this specification, the term “engine” broadly refers to a software-based system, subsystem, or process designed to perform one or more specific functions. An engine is typically implemented as one or more software modules or components installed on one or more computers, which can be located at a single site or distributed across multiple locations. In some instances, one or more dedicated computers may be used for a particular engine, while in other cases, multiple engines may operate concurrently on the same one or more computers. Examples of engine functions within the context of AI and machine learning could include data pre-processing and cleaning, feature engineering and extraction, model training and optimization, inference and prediction generation, and post-processing of results. The specific design and implementation of engines will depend on the overall architecture and the distribution of computational tasks across various hardware components, including CPUs, GPUs, TPUs, and other specialized processors.

The processes and logic flows described in this specification can be executed by one or more programmable computers running one or more computer programs to perform functions by operating on input data and generating output. Additionally, graphics processing units (GPUs) and tensor processing units (TPUs) can be utilized to enable concurrent execution of aspects of these processes and logic flows, significantly accelerating performance. This approach offers significant advantages for computationally intensive tasks often found in AI and machine learning applications, such as matrix multiplications, convolutions, and other operations that exhibit a high degree of parallelism. By leveraging the parallel processing capabilities of GPUs and TPUs, significant speedups and efficiency gains compared to relying solely on CPUs can be achieved. Alternatively or in combination with programmable computers and specialized processors, these processes and logic flows can also be implemented using specialized processing hardware, such as field-programmable gate arrays (FPGAs) or application-specific integrated circuits (ASICs), for even greater performance or energy efficiency in specific use cases.

Computers capable of executing a computer program can be based on general-purpose microprocessors, special-purpose microprocessors, or a combination of both. They can also utilize any other type of central processing unit (CPU). Additionally, graphics processing units (GPUs), tensor processing units (TPUs), and other machine learning accelerators can be employed to enhance performance, particularly for tasks involving artificial intelligence and machine learning. These accelerators often work in conjunction with CPUs, handling specialized computations while the CPU manages overall system operations and other tasks. Typically, a CPU receives instructions and data from read-only memory (ROM), random access memory (RAM), or both. The elements of a computer include a CPU for executing instructions and one or more memory devices for storing instructions and data. The specific configuration of processing units and memory will depend on factors like the complexity of the AI model, the volume of data being processed, and the desired performance and latency requirements. Embodiments can be implemented on a wide range of computing platforms, from small embedded devices with limited resources to large-scale data center systems with high-performance computing capabilities. The system may include storage devices like hard drives, SSDs, or flash memory for persistent data storage.

Computer-readable media suitable for storing computer program instructions and data encompass all forms of non-volatile memory, media, and memory devices. Examples include semiconductor memory devices such as read-only memory (ROM), solid-state drives (SSDs), and flash memory devices; hard disk drives (HDDs); optical media; and optical discs such as CDs, DVDs, and Blu-ray discs. The specific type of computer-readable media used will depend on factors such as the size of the data, access speed requirements, cost considerations, and the desired level of portability or permanence.

To facilitate user interaction, embodiments of the subject matter described in this specification can be implemented on a computing device equipped with a display device, such as a liquid crystal display (LCD) or an organic light-emitting diode (OLED) display, for presenting information to the user. Input can be provided by the user through various means, including a keyboard), touchscreens, voice commands, gesture recognition, or other input modalities depending on the specific device and application. Additional input methods can include acoustic, speech, or tactile input, while feedback to the user can take the form of visual, auditory, or tactile feedback. Furthermore, computers can interact with users by exchanging documents with a user's device or application. This can involve sending web content or data in response to requests or sending and receiving text messages or other forms of messages through mobile devices or messaging platforms. The selection of input and output modalities will depend on the specific application and the desired form of user interaction.

Machine learning models can be implemented and deployed using machine learning frameworks, such as TensorFlow or JAX. These frameworks offer comprehensive tools and libraries that facilitate the development, training, and deployment of machine learning models.

Embodiments of the subject matter described in this specification can be implemented within a computing system comprising one or more components, depending on the specific application and requirements. These may include a back-end component, such as a back-end server or cloud-based infrastructure; an optional middleware component, such as a middleware server or application programming interface (API), to facilitate communication and data exchange; and a front-end component, such as a client device with a user interface, a web browser, or an app, through which a user can interact with the implemented subject matter. For instance, the described functionality could be implemented solely on a client device (e.g., for on-device machine learning) or deployed as a combination of front-end and back-end components for more complex applications. These components, when present, can be interconnected using any form or medium of digital data communication, such as a communication network like a local area network (LAN) or a wide area network (WAN) including the Internet. The specific system architecture and choice of components will depend on factors such as the scale of the application, the need for real-time processing, data security requirements, and the desired user experience.

The computing system can include clients and servers that may be geographically separated and interact through a communication network. The specific type of network, such as a local area network (LAN), a wide area network (WAN), or the Internet, will depend on the reach and scale of the application. The client-server relationship is established through computer programs running on the respective computers and designed to communicate with each other using appropriate protocols. These protocols may include HTTP, TCP/IP, or other specialized protocols depending on the nature of the data being exchanged and the security requirements of the system. In certain embodiments, a server transmits data or instructions to a user's device, such as a computer, smartphone, or tablet, acting as a client. The client device can then process the received information, display results to the user, and potentially send data or feedback back to the server for further processing or storage. This allows for dynamic interactions between the user and the system, enabling a wide range of applications and functionalities.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A computer-implemented method for training a neural network model, the method comprising, at each of a plurality of training iterations:
receiving a set of training examples, wherein each training example comprises an input and target output;
for each training example, generating a respective predicted output by processing the input using the neural network model in accordance with a set of parameter values of the neural network model;
computing a first gradient of a loss function with respect to the set of parameter values of the neural network model using the respective predicted outputs for the inputs;
determining, using the first gradient, a perturbation vector that results in a perturbed set of parameter values that optimizes a measure of functional sharpness, wherein the perturbed set of parameter values are generated by applying the perturbation vector to the set of parameter values;
computing a second gradient of the loss function of the perturbed set of parameter values of the neural network model; and
updating the set of parameter values of the neural network model in accordance with the second gradient.

2. The method of claim 1, wherein the measure of functional sharpness measures a tendency of the respective predicted outputs for each of the inputs to change when the set of parameter values are perturbed.

3. The method of claim 1, wherein determining the perturbation vector that results in the set of perturbed parameter values that optimize the measure of functional sharpness comprises:
identifying a maximal loss perturbation vector that approximates a perturbation vector that results in a perturbed set of parameter values that maximize the loss function;
identifying a first component of the first gradient that relates to the measure of functional sharpness; and
generating the perturbation vector by projecting the maximal loss perturbation vector along a direction that optimizes the measure of functional sharpness using a derivative of the first component of the first gradient.

4. The method of claim 3, wherein the maximal loss perturbation vector is a maximal local loss perturbation vector that is determined within a neighborhood defined by a locality parameter, and wherein the measure of functional sharpness is a local measure of functional sharpness in the neighborhood defined by the locality parameter.

5. The method of claim 3, further comprising:
determining values of a preconditioning matrix in accordance with eliminating a component of the maximal loss perturbation vector that relates to optimizing a measure of logit sharpness; and
prior to generating the perturbation vector, applying the preconditioning matrix to the maximal loss perturbation vector.

6. The method of claim 1, wherein determining the perturbation vector that results in the set of perturbed parameter values that optimize the measure of functional sharpness comprises:
identifying a maximal loss perturbation vector that approximates a perturbation vector that results in a perturbed set of parameter values that maximize the loss function;
determining values of a preconditioning matrix in accordance with eliminating a component of the maximal loss perturbation vector that relates to optimizing a measure of logit sharpness; and
applying the preconditioning matrix to the maximal loss perturbation vector to generate the perturbation vector.

7. The method of claim 6, wherein determining values of the preconditioning matrix comprises:
bootstrapping values of the preconditioning matrix using diagonal preconditioning of an approximation of a second moment of the first gradient.

8. The method of claim 1, wherein determining the perturbation vector that results in the set of perturbed parameter values that optimize the measure of functional sharpness and computing a second gradient of the loss function of the perturbed set of parameter values of the neural network model comprises:
identifying a maximal loss perturbation vector that approximates a perturbation vector that results in a perturbed set of parameter values that maximize the loss function;
applying the maximal loss perturbation vector to the set of parameter values to generate the perturbed set of parameter values;
computing a maximal loss gradient of the set of perturbed parameter values using the perturbed set of parameter values; and
generating an approximation of the second gradient by applying a derivative of the loss function with respect to the outputs to the maximal loss gradient.

9. The method of claim 1, further comprising, at one or more of the training iterations:
determining whether to update the neural network model using the measure of functional sharpness or a measure of logit sharpness.

10. The method of claim 9, wherein determining whether to update the neural network model using the measure of functional sharpness or the measure of logit sharpness comprises determining whether to update the neural network model using the measure of logit sharpness or the measure of functional sharpness based on one or more of: a magnitude of a derivative of a first component of the first gradient, a magnitude of a derivative of a second component of the first gradient, or a measure of correlation between the magnitude of the derivative of the first component and the magnitude of the derivative of the second component.

11. The method of claim 1, wherein applying the perturbation vector to the set of parameter values comprises:
applying the perturbation vector to only a proper subset of the set of parameter values.

12. The method of claim 1, wherein determining the perturbation vector further comprises:
scaling a maximal loss perturbation vector that approximates a perturbation vector that results in a perturbed set of parameter values that maximize the loss function using a set of one or more locality parameters, wherein each locality parameter in the set corresponds with a respective subset of the set of parameter values of the neural network model.

13. The method of claim 12, wherein each of the set of one or more locality parameters is tunable in accordance with an objective function.

14. A computer-implemented method for training a neural network model, the method comprising, at each of a plurality of training iterations:
receiving a set of training examples, wherein each training example comprises an input and target output;
for each training example, generating a respective predicted output by processing the input using the neural network model in accordance with a set of parameter values of the neural network model;
computing a first gradient of a loss function with respect to the set of parameter values of the neural network model using the respective predicted outputs for the inputs;
determining, using the first gradient, a perturbation vector that results in a perturbed set of parameter values that optimizes a measure of logit sharpness, wherein the perturbed set of parameter values are generated by applying the perturbation vector to the set of parameter values;
computing a third gradient of the loss function of the perturbed set of parameter values of the neural network model; and
updating the set of parameter values of the neural network model in accordance with the third gradient.

15. The method of claim 14, wherein the measure of logit sharpness is indicative of a tendency of logits used in calculating the loss function to change when the set of parameter values are perturbed.

16. The method of claim 14, wherein determining the perturbation vector that results in the set of perturbed parameter values that optimize the measure of logit sharpness comprises:
identifying a maximal loss perturbation vector that approximates a perturbation vector that results in a perturbed set of parameter values that maximize the loss function;
identifying a second component of the first gradient that relates to the measure of logit sharpness; and
generating the perturbation vector by projecting the maximal loss perturbation vector along a direction that optimizes the measure of logit sharpness using a derivative of the second component of the first gradient.

17. The method of claim 14, further comprising, at one or more of the training iterations:
determining whether to update the neural network model using the measure of logit sharpness or a measure of functional sharpness.

18. The method of claim 17, wherein determining whether to update the neural network model using the measure of logit sharpness or the measure of functional sharpness comprises determining whether to update the neural network model using the measure of logit sharpness or the measure of functional sharpness based on one or more of: a magnitude of a derivative of a first component of the first gradient, a magnitude of a derivative of the second component of the first gradient, or a measure of correlation between the magnitude of the derivative of the first component and the magnitude of the derivative of the second component.

19. The method of claim 14, wherein applying the perturbation vector to the set of parameter values comprises:
applying the perturbation vector to only a proper subset of the set of parameter values.

20. The method of claim 14, wherein determining the perturbation vector further comprises:
scaling a maximal loss perturbation vector that approximates a perturbation vector that results in a perturbed set of parameter values that maximize the loss function using a set of one or more locality parameters, wherein each locality parameter in the set corresponds with a respective subset of the set of parameter values of the neural network model.

21. The method of claim 19, wherein each of the set of one or more locality parameters is tunable in accordance with an objective function.

22. A method performed by one or more computers, the method comprising:
receiving a new input; and
processing the new input using a neural network model to generate a new output for the new input, wherein the neural network model has been trained by performing the operations of the respective method of claim 1.

23. A method performed by one or more computers, the method comprising:
receiving a new input; and
processing the new input using a neural network model to generate a new output for the new input, wherein the neural network model has been trained by performing the operations of the respective method of claim 14.
